(19) United States
(12) Patent Application Publication
(10) Pub. No.: US 2021/0251019 A1
(43) Pub. Date: Aug. 12, 2021

(54) SYSTEMS AND METHODS FOR PROVISIONING WI-FI DEVICES

(71) Applicant: Microchip Technology Incorporated, Chandler, AZ (US)

(72) Inventor: Amr Sayed, Chandler, AZ (US)

(73) Assignee: Microchip Technology Incorporated, Chandler, AZ (US)

(21) Appl. No.: 16/986,447

(22) Filed: Aug. 6, 2020

Related U.S. Application Data
(60) Provisional application No. 62/972,250, filed on Feb. 10, 2020.

(51) Int. Cl. H04W 76/10; H04W 12/06

(52) U.S. Cl. CPC H04W 76/10; H04W 84/12; H04W 12/0609

(57) ABSTRACT

Systems and methods are provided for automated provisioning (connection) of Wi-Fi devices to a Wi-Fi network in which another Wi-Fi device is already provisioned (connected) to the network. A non-provisioned Wi-Fi device automatically obtains Wi-Fi network security credentials from the already-provisioned Wi-Fi device, and uses the obtained credentials to connect itself to the network. In some embodiments, the only manual steps involved in provisioning the non-provisioned Wi-Fi device are (a) placing the already-provisioned Wi-Fi device into an “access point mode” (e.g., by pressing a button on the already-provisioned device) and/or (b) placing the non-provisioned Wi-Fi device into an “enrollment mode” (e.g., by powering up the non-provisioned Wi-Fi device). After these user action(s), the non-provisioned Wi-Fi device automatically obtains the Wi-Fi network security credentials (e.g., access point name and network password) from the already-provisioned Wi-Fi device and uses such credentials to automatically connect itself to the Wi-Fi network.

### RELATED APPLICATION

This application claims priority to commonly owned U.S. Provisional Patent Application No. 62/972,250 filed Feb. 10, 2020, the entire contents of which are hereby incorporated by reference for all purposes.

### TECHNICAL FIELD

The present disclosure relates to Wi-Fi devices, and more particularly, to systems and method for provisioning Wi-Fi devices, i.e., connecting Wi-Fi devices to a Wi-Fi network.

### BACKGROUND

Wi-Fi is a very common, if not the most common, wireless networking technology in use today, in particular for local area networking of devices and internet access. Wi-Fi was originally developed to allow mobile devices, such as laptops, tablets, and smartphones to connect to the Internet, and is now being incorporated into numerous other types of devices, such as thermostats, home appliances, door locks, and cameras, which collectively define an “Internet of Things” (IoT). Devices designed to wirelessly connect to a Wi-Fi network are referred to herein as “Wi-Fi devices.”

The process of connecting a Wi-Fi device to a Wi-Fi network, for example by connecting the Wi-Fi device to a Wi-Fi router or access point, is commonly described as “provisioning” the Wi-Fi device. The process of provisioning a Wi-Fi device to a Wi-Fi network typically involves providing the device with authentication (security) credentials of the network, usually including the name of the Wi-Fi network or network access point (e.g., SSID) and a password.

There are a number of conventional ways to provision a Wi-Fi device. For example, a user may use “terminal commands,” in which the user physically connects a Wi-Fi device to a PC or other computer (e.g., by a USB connection), opens a terminal program on the PC or other computer, and types a series of manual commands to program the Wi-Fi device with the network security credentials of the network (e.g., the name and security setting of a Wi-Fi access point, and a network password). The Wi-Fi device then uses the network security credentials to connect to the Wi-Fi access point to join the Wi-Fi network.

As another example, a user may provision a Wi-Fi device with a mobile provisioning application. The user may download a designated mobile provisioning application to their smartphone or other mobile device. The mobile provisioning application may be preconfigured with a Wi-Fi access point name (e.g., router name). The user enters the access point name and password via the mobile provisioning application, which then attempts to connect to the Wi-Fi access point using these security credentials. If the mobile provisioning application successfully connects to the access point using the user-entered security credentials, the mobile provisioning application then sends the security credentials to the Wi-Fi device, which then uses the security credentials to connect to the access point to join the Wi-Fi network.

As still another example, a user may provision a Wi-Fi device using a USB mass storage device (MSD), wherein the user physically connects the Wi-Fi device to a PC or other computer by USB cable, generates a text file with the network security credentials (e.g., Wi-Fi access point name and network password) using a predefined format (typically defined by the manufacturer/vendor of the Wi-Fi device being provisioned), and then drag-and-drops the file from the PC to an MSD. The Wi-Fi device then reads the text file from the MSD and connects to the Wi-Fi network using the network security credentials.

As another example, some Wi-Fi devices include a screen, keypad, or other user interface that enables a user to enter the relevant network security credentials allowing the Wi-Fi device to connect to a Wi-Fi network.

With each of these conventional provisioning techniques, a user (or users) must repeat a series of time-consuming steps to add each respective Wi-Fi device to a network, such as downloading a mobile provisioning application, physically connecting the respective Wi-Fi device to a PC, and/or manually programing the respective Wi-Fi device with the relevant network security credentials. This repeated process may be particularly inefficient in networks with multiple (or many) Wi-Fi devices to be provisioned, for example device manufacturers that need to test hundreds or thousands of Wi-Fi devices.

Thus, there is a need for an easier, more efficient way to connect multiple Wi-Fi devices to a Wi-Fi network.

### SUMMARY

Embodiments of the present invention provide systems and methods for automated provisioning (connection) of Wi-Fi devices to a Wi-Fi network in which another Wi-Fi device is already provisioned (connected) to the network. A non-provisioned Wi-Fi device automatically obtains Wi-Fi network security credentials from the already-provisioned Wi-Fi device, and uses the obtained credentials to connect itself to the network. In some embodiments, the only manual steps involved in provisioning the non-provisioned Wi-Fi device are (a) placing the already-provisioned Wi-Fi device into an “access point mode” (e.g., by pressing a button on the already-provisioned device) and/or (b) placing the non-provisioned Wi-Fi device into an “enrollment mode” (e.g., by powering up the non-provisioned Wi-Fi device). After these user action(s), the non-provisioned Wi-Fi device automatically obtains the Wi-Fi network security credentials (e.g., access point name and network password) from the already-provisioned Wi-Fi device and uses such credentials to automatically connect itself to the Wi-Fi network.

As used herein, an “automated” provisioning process refers to a process for provisioning a non-provisioned Wi-Fi device in which at least the steps involved in the non-provisioned Wi-Fi device obtaining the Wi-Fi network security credentials from an already-provisioned W-Fi device are performed by the respective devices automatically, without human action (e.g., without a user entering the network security credentials at a computer interface, a Wi-Fi device interface, or using a mobile device application, for example).

The disclosed systems and methods may provide a faster and more convenient way for Wi-Fi device end users/customers to connect multiple Wi-Fi devices to a network. After a first Wi-Fi device is provisioned (e.g., using conventional techniques), each additional Wi-Fi device may be added to the network in a seamless automated manner (by obtaining the network security credential from the first Wi-Fi device), without the need for the user to download and operate a mobile provisioning application and/or manually enter the network security credentials for each additional Wi-Fi device. In addition, the disclosed systems and methods may provide device manufacturers or vendors a much faster and more convenient way to test and develop Wi-Fi devices/modules/chips in their facilities, e.g., where 100s or 1000s of devices may need to be developed and/or tested.

One aspect of the invention provides a method for provisioning Wi-Fi devices to a Wi-Fi network. A first Wi-Fi device is connected to a Wi-Fi access point using a first provisioning process, for example any conventional provisioning process. For example, the first Wi-Fi device may be provisioned using (a) manual entry of terminal commands, (b) using a Wi-Fi Protected Setup (WPS) process, (c) using a mobile provisioning application to communicate access point authentication information to the first Wi-Fi device, or (d) using a mass storage device (MSD).

After provisioning the first Wi-Fi device to the Wi-Fi access point, at least one second Wi-Fi device may be connected to the Wi-Fi access point by a second provisioning process, which may be fully or nearly fully automated. The second provisioning process for each respective second Wi-Fi device to the Wi-Fi access point may include (a) establishing a wireless communication connection between the first Wi-Fi device and the respective second Wi-Fi device, (b) the respective second Wi-Fi device obtaining access point authentication information from the first Wi-Fi device via the established wireless communication connection, the access point authentication information allowing authenticated connection to the Wi-Fi access point, and (c) the respective second Wi-Fi device using the access point authentication information received from the first Wi-Fi device to connect to the Wi-Fi access point.

In some embodiments, the second provisioning process further includes, prior to the respective second Wi-Fi device obtaining the access point authentication information from the first Wi-Fi device, the second Wi-Fi device authenticating the first Wi-Fi device based on a first device authentication information received from the first Wi-Fi device, and the first Wi-Fi device authenticating the respective second Wi-Fi device based on a second device authentication information received from the respective second Wi-Fi device. In some embodiments, the second device authentication information comprises a digital certificate stored in the respective second Wi-Fi device.

In some embodiments, the first Wi-Fi device is configured to operate in both (a) a station mode in which the first Wi-Fi device acts as a slave to the Wi-Fi access point and (b) an access point mode in which the first Wi-Fi device acts as a Wi-Fi access point to the respective second Wi-Fi device to enable the transfer of the access point authentication information to the respective second Wi-Fi device for provisioning the second Wi-Fi device. In some embodiments, the first Wi-Fi device is configured to concurrently operate in both the station mode and the access point mode. In other embodiments, the first Wi-Fi device is configured to alternatingly operate in the station mode and the access point mode.

In some embodiments, the second provisioning process further includes, prior to the respective second Wi-Fi device obtaining the access point authentication information from the first Wi-Fi device, activating the access point mode of the first Wi-Fi device to enable the transfer of the access point authentication information to the respective second Wi-Fi device, and activating the enrollment mode of the respective second Wi-Fi device.

In some embodiments, the access point mode of the first Wi-Fi device is activated by a user pressing a physical interface (e.g., a button) provided on the first Wi-Fi device. In some embodiments, the enrollment mode of the respective second Wi-Fi device is activated by powering on the respective second Wi-Fi device.

In some embodiments, the step of activating the enrollment mode of the respective second Wi-Fi device is performed after the step of activating the access point mode of the first Wi-Fi device, and automatically triggering the respective second Wi-Fi device to transmits an access point probe, which is received by the first Wi-Fi device in the access point mode, and which causes the first Wi-Fi device to transmit a response to the access point probe to the respective second Wi-Fi device.

In some embodiments, after the access point mode of the first Wi-Fi device is activated and the enrollment mode of the respective second Wi-Fi device is activated, the steps of the respective second Wi-Fi device obtaining the access point authentication information from the first Wi-Fi device and the respective second Wi-Fi device using the access point authentication information to connect to the Wi-Fi access point are performed automatically without human participation.

In some embodiments, the access point authentication information is stored in the first Wi-Fi device during the first provisioning process. In some embodiments, the access point authentication information is input by a user and stored in the first Wi-Fi device during the first provisioning process.

In some embodiments, the first provisioning process for connecting the first Wi-Fi device to the Wi-Fi access point comprises manual entry of terminal commands. In other embodiments, the first provisioning process comprises performing a Wi-Fi Protected Setup (WPS) process. In other embodiments, the first provisioning process comprises using a mobile provisioning application to communicate access point authentication information to the first Wi-Fi device. In other embodiments, the first provisioning process comprises using a mass storage device (MSD).

Another aspect of the invention provides a method for provisioning a second Wi-Fi device to a Wi-Fi network having a first Wi-Fi device already provisioned to the Wi-Fi access point. The first Wi-Fi device may be connected to the Wi-Fi network using a conventional provisioning technique, e.g., any technique discussed in the Background section. For example, the first Wi-Fi device may be provisioned using (a) manual entry of terminal commands, (b) using a Wi-Fi Protected Setup (WPS) process, (c) using a mobile provisioning application to communicate access point authentication information to the first Wi-Fi device, or (d) using a mass storage device (MSD).

Subsequent to the first Wi-Fi device being provisioned, a second Wi-Fi device may be connected to the Wi-Fi network by an automated provisioning process. An access point mode of the first Wi-Fi device may be activated, allowing wireless communications with the respective second Wi-Fi device, and an enrollment mode of the respective second Wi-Fi device may be activated. For example, the access point mode of the first Wi-Fi device may be activated in response to a user pressing or actuating a designated physical interface (e.g., a button) on the first Wi-Fi device, and the enrollment mode of the respective second Wi-Fi device may be activated automatically in response to being powered on (e.g., by a user plugging in or actuating a switch or button on the second Wi-Fi device to turn on the device).

In response to the first Wi-Fi device activating the access point mode and the second Wi-Fi device activating the enrollment mode, the first and second Wi-Fi devices automatically perform (i.e., without human interaction) a provisioning information exchange. In particular, the first and second Wi-Fi devices establish a wireless communication connection and perform a device authentication process including (a) the first Wi-Fi device authenticating the second Wi-Fi device based on second Wi-Fi device authentication information received from the second Wi-Fi device and/or (b) the second Wi-Fi device authenticating the first Wi-Fi device based on first Wi-Fi device authentication information received from the first Wi-Fi device.

After the device authentication process, the first Wi-Fi device may communicate access point authentication information to the second Wi-Fi device, and the second Wi-Fi device may use the received access point authentication information to connect the second Wi-Fi device to a Wi-Fi access point of the Wi-Fi network, to thereby provision the second Wi-Fi device.

Thus, in some embodiments, after the activation of the access point mode of the first Wi-Fi device and activation of the enrollment mode of the second Wi-Fi device, the second Wi-Fi device automatically obtains the network security credentials from the first Wi-Fi device and uses such credentials to automatically connect to the Wi-Fi network without human interaction.

In some embodiments, the second Wi-Fi device authentication information used by the first Wi-Fi device for authenticating the second Wi-Fi device comprises a digital certificate stored in the second Wi-Fi device.

In some embodiments, the step of activating the enrollment mode of the second Wi-Fi device is performed after the step of activating the access point mode of the first Wi-Fi device, and automatically triggers the provisioning information exchange. For example, activating the enrollment mode of the second Wi-Fi device may automatically trigger the second Wi-Fi device to perform an access point probe by transmitting an access point probe. The access point probe may be received by the first Wi-Fi device in the access point mode, which may transmit a response to the access point probe for receipt by the second Wi-Fi device.

In some embodiments, the access point authentication information is stored in the first Wi-Fi device during the previous provisioning (e.g., using conventional techniques) of the first Wi-Fi device. For example, in some embodiments, the access point authentication information is input by a user and stored in the first Wi-Fi device during the previous provisioning of the first Wi-Fi device.

Another aspect of the invention provides a Wi-Fi system including a Wi-Fi access point, a first Wi-Fi device configured to be connected to the Wi-Fi access point by a first provisioning process, and at least one second Wi-Fi device. Each respective second Wi-Fi device is configured to interact with the first Wi-Fi device to connect the respective second Wi-Fi device to the Wi-Fi access point by a second provisioning process including: (a) the first Wi-Fi device activating an access point mode allowing wireless communications with the respective second Wi-Fi device; (b) the respective second Wi-Fi device activating an enrollment mode; (c) establishing a wireless communication connection between the first Wi-Fi device in the access point mode and the respective second Wi-Fi device in the enrollment mode; (d) the respective second Wi-Fi device obtaining access point authentication information from the first Wi-Fi device via the established wireless communication connection, the access point authentication information allowing authenticated connection to the Wi-Fi access point; and (e) the respective second Wi-Fi device using the access point authentication information received from the first Wi-Fi device to connect to the Wi-Fi access point.

Another aspect of the invention provides a Wi-Fi system including a Wi-Fi access point, a first Wi-Fi device including a first Wi-Fi device processor and first Wi-Fi device memory coupled to the first Wi-Fi device processor and storing first computer-readable instructions executable by the first Wi-Fi device processor, and a second Wi-Fi device including a second Wi-Fi device processor and second Wi-Fi device memory coupled to the second Wi-Fi device processor and storing second computer-readable instructions executable by the second Wi-Fi device processor. The first Wi-Fi device is configured to be connected to the Wi-Fi access point by a first provisioning process. The first and second Wi-Fi device processors are configured to execute the first and second computer-readable instructions, respectively, to perform a second automated provisioning process to connect the second Wi-Fi device to the Wi-Fi access point.

To perform the second automated provisioning process, the first computer-readable instructions are executed to activate an access point mode of the first Wi-Fi device allowing wireless communications with the second Wi-Fi device, the first and second computer-readable instructions are executed to establish a wireless communication connection between the first and second Wi-Fi devices while the first Wi-Fi device is in the access point mode, and the first and second computer-readable instructions are executed to use the established wireless communication connection to perform a device authentication process. The device authentication process includes the second Wi-Fi device communicating Wi-Fi device authentication information stored in the second Wi-Fi device to the first Wi-Fi device, and the first Wi-Fi device authenticating the second Wi-Fi device based on the Wi-Fi device authentication information received from the second Wi-Fi device. After the device authentication process, the first computer-readable instructions are further executed to communicate access point authentication information from the first Wi-Fi device to the second Wi-Fi device. Finally, the second computer-readable instructions are executed at the second Wi-Fi device to use the access point authentication information received from the first Wi-Fi device to connect the second Wi-Fi device to the Wi-Fi access point.

Another aspect of the invention provides a method for provisioning Wi-Fi devices to a Wi-Fi network. A first Wi-Fi device is connected to a Wi-Fi access point using a first provisioning process, e.g., using any of the conventional provisioning processes discussed above. After connecting the first Wi-Fi device to the Wi-Fi access point, at least one second Wi-Fi device may be connecting to the Wi-Fi access point by a second provisioning process. The second provisioning process for each respective second Wi-Fi device to the Wi-Fi access point includes: activating an access point mode of the first Wi-Fi device allowing wireless communications with other non-provisioned Wi-Fi device; activating an enrollment mode of the respective second Wi-Fi device; and automatically performing a provisioning information exchange including (a) establishing a wireless communication connection between the first Wi-Fi device in the an access point mode and the respective second Wi-Fi device in the enrollment mode and (b) using the established wireless communication connection, performing a device authentication process including the first Wi-Fi device authenticating the respective second Wi-Fi device based on Wi-Fi device authentication information received from the respective second Wi-Fi device; after the device authentication process, the first Wi-Fi device communicating access point authentication information to the respective second Wi-Fi device, the access point authentication information allowing authenticated connection to the Wi-Fi access point; and the respective second Wi-Fi device using the access point authentication information received from the first Wi-Fi device to connect to the Wi-Fi access point.

Another aspect of the invention provides a method for provisioning a second Wi-Fi device after a first Wi-Fi device is provisioned. First, the first Wi-Fi device connects to a Wi-Fi access point. Subsequently, to provision the second Wi-Fi device, an access point mode of the first Wi-Fi device is activated, allowing wireless communications with other Wi-Fi devices. While the first Wi-Fi device is in the access point mode: (a) the first Wi-Fi device establishes a wireless communication connection with a second Wi-Fi device; (b) the first Wi-Fi device authenticates the second Wi-Fi device based on Wi-Fi device authentication information received from the second Wi-Fi device, and (c) after the device authentication process, the first Wi-Fi device communicates access point authentication information to the second Wi-Fi device, which allows the second Wi-Fi device to connect to the Wi-Fi access point.

Another aspect of the invention provides a Wi-Fi device including a provisioning system of the Wi-Fi device including a processor and logic instructions stored in non-transitory computer-readable media. The logic instructions may be executable by the processor to connect to a Wi-Fi access point, activate an access point mode of a first Wi-Fi device allowing wireless communications with other Wi-Fi devices, and while in the access point mode: (a) establish a wireless communication connection with a second Wi-Fi devices, (b) receive Wi-Fi device authentication information from the second Wi-Fi device, (c) authenticate the second Wi-Fi device based on the Wi-Fi device authentication information received from the second Wi-Fi device, and (d) after authenticating the second Wi-Fi device, communicate access point authentication information to the second Wi-Fi device, which allows the second Wi-Fi device to connect to the Wi-Fi access point.

Another aspect of the invention provides a method for provisioning a second Wi-Fi device to a Wi-Fi access point of a Wi-Fi network having a first Wi-Fi device previously provisioned to the Wi-Fi access point. The method includes activating an enrollment mode of the second Wi-Fi device, and while the second Wi-Fi device is in the enrollment mode: (a) the second Wi-Fi device establishing a wireless communication connection with the first Wi-Fi device, (b) the second Wi-Fi device performing a device authentication process to authenticate itself with the first Wi-Fi device, including communicating Wi-Fi device authentication information stored in the second Wi-Fi device to the first Wi-Fi device, (c) in response to a successful completion of the device authentication process, the second Wi-Fi device receiving access point authentication information from the first Wi-Fi device, the access point authentication information allowing authenticated connection to the Wi-Fi access point, and (d) the second Wi-Fi device using the access point authentication information received from the first Wi-Fi device to connect the second Wi-Fi device to the Wi-Fi access point.

Another aspect of the invention provides a Wi-Fi device configured for automated provisioning to a Wi-Fi access point of a Wi-Fi network having a provisioned Wi-Fi device previously provisioned to the Wi-Fi access point. The Wi-Fi device includes a provisioning system of the Wi-Fi device including a processor and logic instructions stored in non-transitory computer-readable media and executable by the processor to activate an enrollment mode of the second Wi-Fi device, and while in the enrollment mode: (a) establish a wireless communication connection with the provisioned Wi-Fi device, (b) perform a device authentication process to authenticate the Wi-Fi device with the provisioned Wi-Fi device, including communicating Wi-Fi device authentication information stored in the Wi-Fi device to the provisioned Wi-Fi device, (c) in response to a successful completion of the device authentication process, receive access point authentication information from the provisioned Wi-Fi device, and (d) use the access point authentication information received from the provisioned Wi-Fi device to connect the Wi-Fi device to the Wi-Fi access point.

In some embodiments, a first Wi-Fi device is configured to operate in both (a) a station mode in which the first Wi-Fi device acts as a slave to a network access point (e.g., router) of a Wi-Fi network to which the first Wi-Fi device is connected and (b) an access point mode in which the first Wi-Fi device acts and appears as an Wi-Fi access point to non-provisioned Wi-Fi devices, to allow each non-provisioned Wi-Fi device to communicate with the first Wi-Fi device, in particular to allow each non-provisioned Wi-Fi devices to obtain network security credentials (e.g., network access point name and network password) directly from the first Wi-Fi device, which each non-provisioned Wi-Fi device may then use to connect to the Wi-Fi network. In some embodiments, the first Wi-Fi device may operate in both the station mode and the access point mode concurrently. In other embodiments, the first Wi-Fi device may be configured to selectively switch between the station mode and access point mode, e.g., operate in the station mode during normal operation and temporarily switch over to the access point mode to facilitate the provisioning of a non-provisioned device.

### BRIEF DESCRIPTION OF THE FIGURES

Example aspects of the present disclosure are described below in conjunction with the figures, in which:

FIG. 1 shows an example system for provisioning Wi-Fi devices to a Wi-Fi network, according to an example embodiment of the present invention;

FIG. 2 shows a flowchart of an example method for provisioning Wi-Fi devices to a network, according to an example embodiment of the present invention; and

FIG. 3A illustrate an example method of provisioning a first Wi-Fi device to a network, and FIG. 3B illustrates an example method of provisioning a second Wi-Fi device to the network by obtaining network security credentials from the already-provisioned first Wi-Fi device, according to an example embodiment of the present invention.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

Embodiments of the present invention provide systems and methods for automated provisioning (connection) of Wi-Fi devices to a Wi-Fi network in which another Wi-Fi device is already provisioned (connected) to the network. A non-provisioned Wi-Fi device automatically obtains Wi-Fi network security credentials from the already-provisioned Wi-Fi device, and uses the obtained credentials to connect itself to the network. In some embodiments, the only manual steps involved in provisioning the non-provisioned Wi-Fi device are (a) placing the already-provisioned Wi-Fi device into an “access point mode” (e.g., by pressing a button on the already-provisioned device) and/or (b) placing the non-provisioned Wi-Fi device into an “enrollment mode” (e.g., by powering up the non-provisioned Wi-Fi device). After these user action(s), the non-provisioned Wi-Fi device automatically obtains the Wi-Fi network security credentials (e.g., access point name and network password) from the already-provisioned Wi-Fi device and uses such credentials to automatically connect itself to the Wi-Fi network.

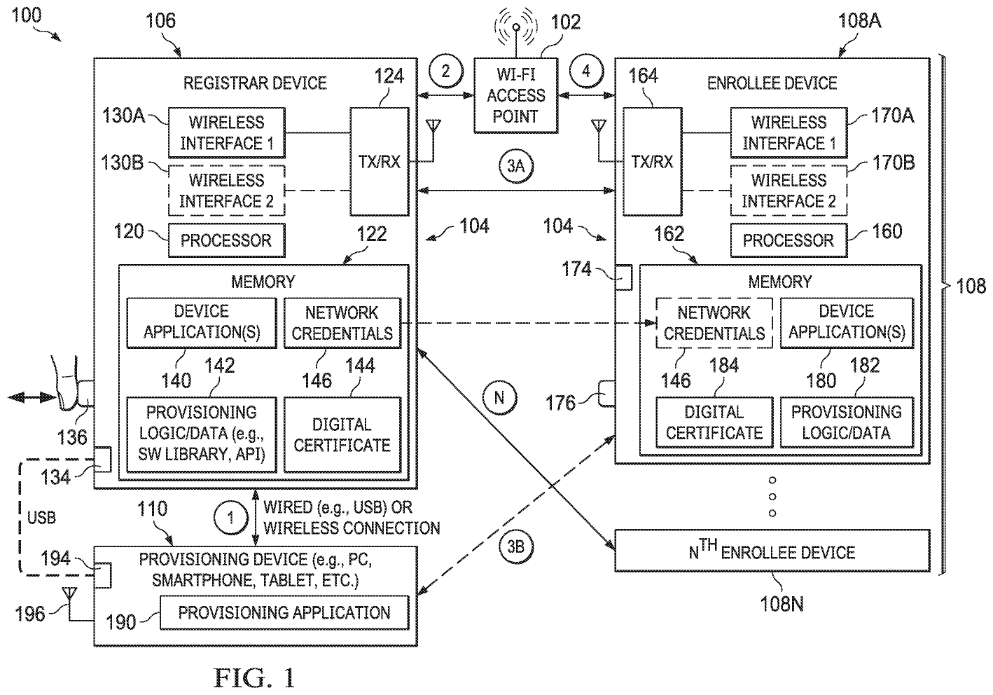

FIG. 1 shows an example system 100 for provisioning Wi-Fi devices to a Wi-Fi network, according to an example embodiment of the present invention. System 100 includes a Wi-Fi access point 102, a plurality of Wi-Fi devices 104, and a manual provisioning device 110. Wi-Fi access point 102 may include any device or group of devices (e.g., at one location or at multiple spaced-apart locations) that provides a portal or interface allowing a number of Wi-Fi devices 104 to connect to a respective network, e.g., the Internet, a local area network (LAN), a wide area network (WAN), or any other type of network. Wi-Fi access point 102 may include any number and type(s) of access point, router, hotspot, or other device(s) configured to allow Wi-Fi devices 104 to connect to the relevant network. For example, in a home or small office environment, Wi-Fi access point 102 may include an integrated router/access point connected to the customer premises equipment (CPE) of an internet service provider (ISP) via a wired Ethernet connection and configured to wirelessly connect with Wi-Fi devices 104 to provide Wi-Fi devices 104 a connection to the Internet and/or to other Wi-Fi devices 104 connected to the integrated router/access point (i.e., other Wi-Fi devices 104 in the same LAN). As another example, in larger business or enterprise, Wi-Fi access point 102 may include a network of access points and switches.

Wi-Fi devices 104 may include any number and types of devices enabled to use Wi-Fi protocol communications to connect to a Wi-Fi network, such as desktops, laptops, tablets, smartphones, smart watches, smart TVs, home appliances, thermostats, lights, printers, digital audio players, digital cameras, cars and drones, for example.

According to some embodiments of the invention, each Wi-Fi device 104 may be classified as a Registrar Device, an Enrollee Device, or a conventional device, based on the particular configuration or programming (e.g., embodied in provisioning logic/data 142 or 182, discussed below) of the respective device. In particular, the terms Registrar Device and Enrollee Device are defined as:
(a) Registrar Device: a respective Wi-Fi device 104 configured or programmed with Wi-Fi registrar functionality to facilitate automated provisioning of other non-provisioned Wi-Fi devices 104 (Enrollee Devices) to the Wi-Fi network, e.g., by sharing network security credentials with such non-provisioned devices (Enrollee Devices) to allow the non-provisioned devices (Enrollee Devices) to connect to the Wi-Fi access point 102.
(b) Enrollee Device: a respective Wi-Fi device 104 device configured or programmed with Wi-Fi enrollee functionality for automated provisioning of the respective device 104 to the Wi-Fi network, e.g., by obtaining network security credentials from a pre-provisioned Registrar Device and using the obtained network security credentials to connect the respective device 104 to the Wi-Fi access point 102. Each Enrollee Device may (or may not) also be configured for conventional provisioning, e.g., for situations in which there is no pre-provisioned Registrar Device present in the network.
(c) Registrar/Enrollee Device: a respective Wi-Fi device is configured or programmed with both (a) Wi-Fi registrar functionality for facilitating automated provisioning of Enrollee Device(s) (e.g., in a situation in which the respective Wi-Fi device is provisioned prior to the Enrollee Device(s)) and (b) Wi-Fi enrollee functionality for facilitating automated provisioning of itself via another, pre-provisioned Registrar Device (e.g., in a situation in which the respective Wi-Fi device is provisioned after the other, pre-provisioned Registrar Device). A Registrar/Enrollee Device may also be configured for conventional provisioning, e.g., for situations in which there is no pre-provisioned Registrar Device present in the network.

It should be understood that the device type Registrar/Enrollee Device is a subset of the device type Registrar Device and also a subset of the device type Enrollee Device, such that any device described herein as a Registrar Device (e.g., Registrar Device 106) or an Enrollee Device (e.g., Enrollee Devices 108A . . . 108N) may (or may not) be a Registrar/Enrollee Device, unless otherwise explicitly stated.

In the example of FIG. 1, the illustrated Wi-Fi devices 104 include a Registrar Device 106 and one or more Enrollee Devices 108 (illustrated as Enrollee Devices 108A . . . 108N). In this example, Registrar Device 106 is pre-provisioned (connected to Wi-Fi access point 102) prior to the one or more Enrollee Devices 108. Each Enrollee Device 108 may be subsequently provisioned by the automated provisioning process disclosed herein, e.g., by obtaining network security credentials from the pre-provisioned Registrar Device 106 and using the obtained network security credentials to provision the respective Enrollee Device 108.

As shown, Registrar Device 106 may include a processor 120, memory 122, transmitter/receiver unit 124, wired connection interface(s) 134, a registration mode input device 136, and other various other electronic components. Processor 120 may include one or more of a general purpose microprocessor, microcontroller, Application Specific System Processor (ASSP), Application Specific Integrated Circuit (ASIC), Digital Signal Processor (DSP), or any other devices for executing computer instructions.

Memory 122 may include one or more data storage devices, for example, any one or combination of hard drives, RAM, ROM, EEPROM, Flash memory, or removable memory device (e.g., USB drives, or MSD), without limitation. Memory 122 may store executable instructions and other relevant data to provide the various functionalities of Registrar Device 106. For example, memory 122 may store one or more device applications 140, provisioning logic/data 142, a digital certificate 144, and network security credentials 146 (for connecting to Wi-Fi access point 102). Device applications 140 may include executable code (e.g., software, logic instructions, or computer readable instruction which may enable processor 120 to perform functions described herein) and data for operating the Registrar Device 106, including managing wireless interface 130A and/or 130B, discussed below.

Provisioning logic/data 142 may include executable code (e.g., software, logic instructions, or computer readable instruction which may enable processor 120 to perform functions described herein) and data (a) to facilitate provisioning of the Registrar Device 106 by a conventional/manual technique, e.g., via a suitable manual provisioning device 110, discussed below, and (b) to provide Wi-Fi registrar functionality to facilitate automated provisioning of Enrollee Devices 108, e.g., by sharing network security credentials 146 with Enrollee Devices 108. Where Registrar Device 106 is a Registrar/Enrollee Device, provisioning logic/data 142 may also include executable code (e.g., software, logic instructions, or computer readable instruction which may enable processor 120 to perform functions described herein) and data to provide Wi-Fi enrollee functionality for automated provisioning of the Registrar/Enrollee Device 106 via another Registrar Device, e.g., in a situation in which Registrar Device 106 is added to the network after another Registrar Device has already been provisioned in the network (i.e., Registrar Device 106 acts as an Enrollee Device in such situation).

Provisioning logic/data 142 may include one or more software libraries, APIs, and/or other types of computer-readable code and/or data.

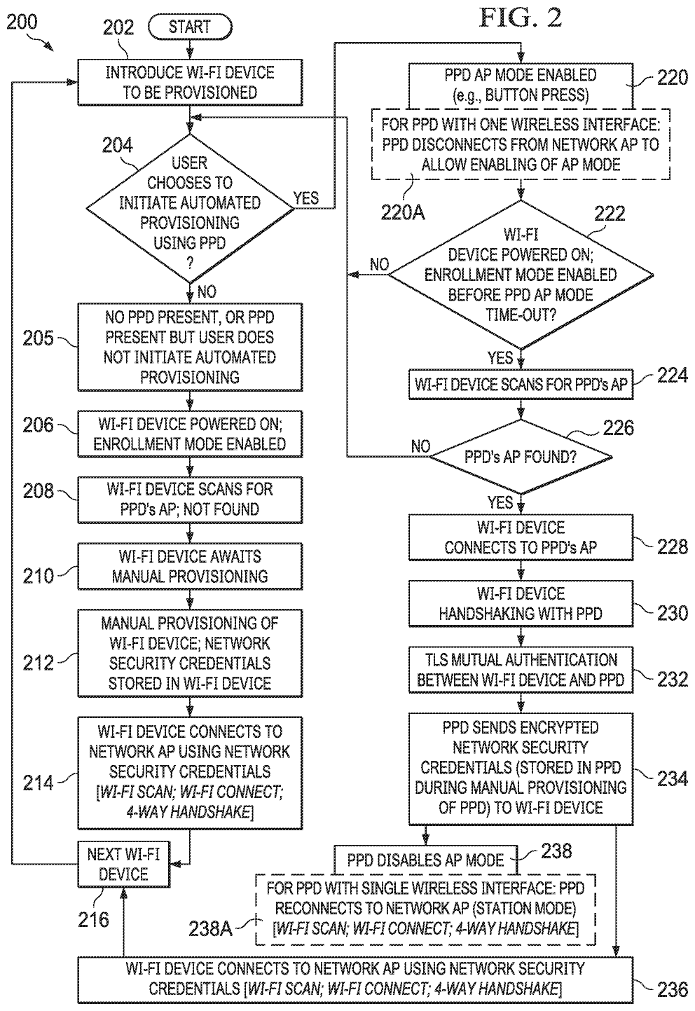

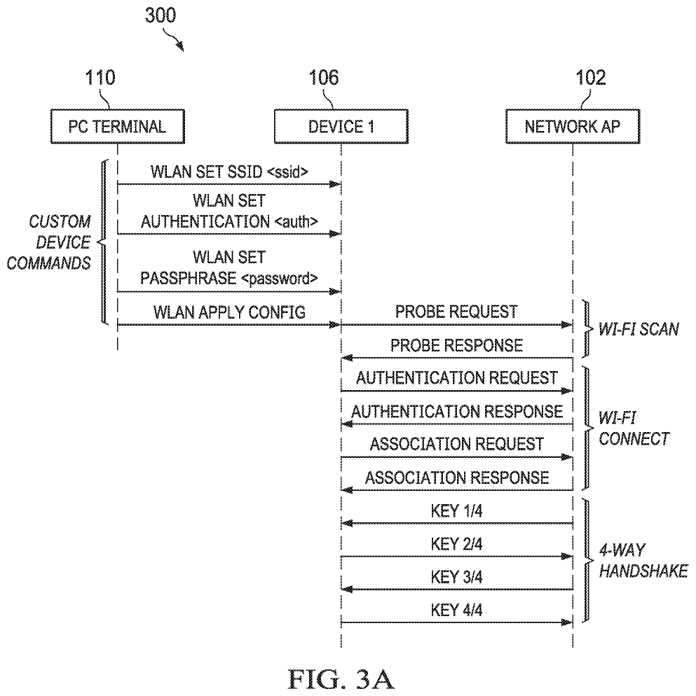

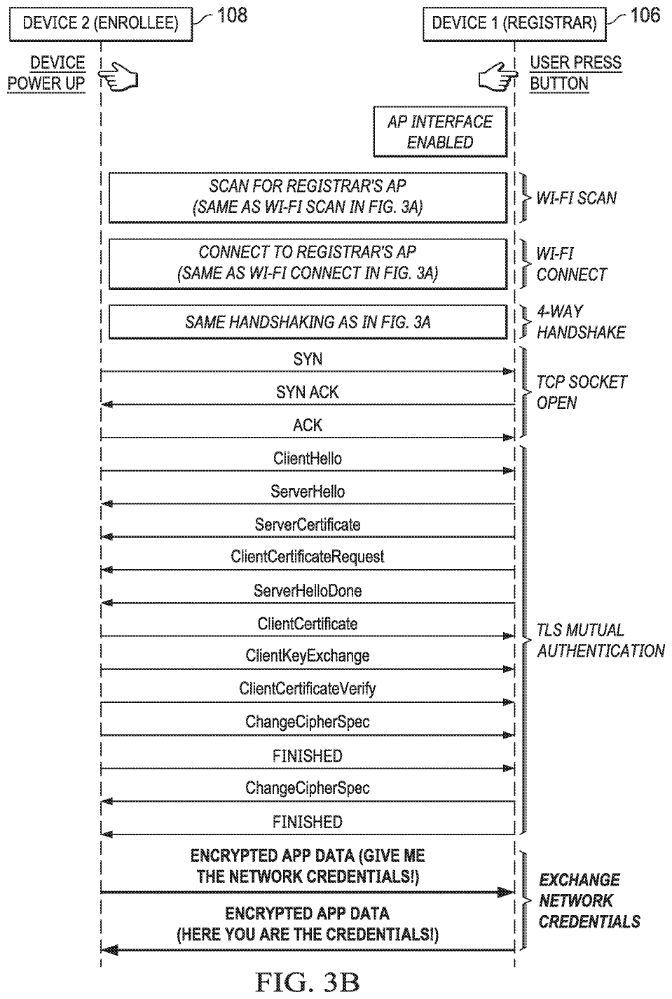

Digital certificate 144 may comprise a signed digital certificate, e.g., a digital file signed by a manufacturer or vendor of Device 1, which may be used by other Wi-Fi devices (e.g., Device 2) to authenticate Device 1 before sharing sensitive information, e.g., during a TLS mutual authentication process such as discussed below with reference to FIG. 2 (step 232) and FIG. 3B (“TLS MUTUAL AUTHENTICATION”).

Transmitter/receiver unit 124 may include any hardware, circuitry, software, and/or firmware for transmitting and receiving wireless communications.

Registrar Device 106 may be (a) a single-interface device including a single wireless interface 130A allowing a single wireless connection at any given time via transmitter/receiver unit 124, or (b) a dual-interface device including two wireless interfaces 130A and 130B allowing two concurrent wireless connections via transmitter/receiver unit 124 (e.g., a first wireless connection with Wi-Fi access point 102 and a second wireless connection with an Enrollee Device 108 being provisioned). Each wireless interfaces 130A, 130B may include any suitable hardware, circuitry, software, and/or firmware for providing a discrete wireless interface via transmitter/receiver unit 124.

A dual-interface Registrar Device may use one wireless interface 130A or 130B for provisioning the Registrar Device 106 by a manual provisioning device 110. Then, once connected to the Wi-Fi access point 102, the dual-interface Registrar Device may concurrently operate in both (a) a station mode (Registrar STA Mode) for connection to Wi-Fi access point 102, via a first wireless interface 130A or 130B, and (b) an access point mode (Registrar AP Mode) to act as an access point to an Enrollee Device 108 to facilitate the provisioning of the Enrollee Device 108, via the other wireless interface 130B or 130A. In some embodiments, provisioning logic/data 142 of a dual-interface Registrar Device may temporarily enable the Registrar AP Mode to assist with the provisioning of each respective Enrollee Device 108 and then disable the Registrar AP Mode after providing such provisioning assistance (e.g., after sharing the network security credentials with the Enrollee Device 108), in order to minimize the potential for external attacks against the dual-interface Registrar Device.

A single-interface Registrar Device may use the single wireless interface 130A for provisioning the Registrar Device 106 by a manual provisioning device 110. Once connected to the Wi-Fi access point 102, the single-interface Registrar Device may switch between (a) a Registrar STA Mode in which the single wireless interface 130A is connected to Wi-Fi access point 102, and (b) a Registrar AP Mode in which the single wireless interface 130A is used as an access point for an Enrollee Device 108 to connect to the Registrar Device to facilitate the provisioning of the Enrollee Device 108. In order to facilitate the provisioning of a new Enrollee Device 108, provisioning logic/data 142 of a single-interface Registrar Device may automatically disconnect an existing network connection via the single wireless interface 130A (i.e., disconnect from Wi-Fi access point 102), use the network-disconnected wireless interface 130A to facilitate the provisioning of the Enrollee Device 108, and then once completed, automatically reconnect to the Wi-Fi access point 102 via the wireless interface 130A.

Wired connection interface(s) 134 may include one or more physical interface (e.g., port, slot, cable, etc.), for example a USB port or USB cable, for physically connecting Registrar Device 106 to corresponding wired connection interface(s) 194 of manual provisioning device 110 for wired provisioning of Registrar Device 106.

Registration mode input device 136 may include any physically actuatable device or element, for example a button, switch, slider, or touch screen arranged to detect a predetermined gesture, for placing Registrar Device 106 into a registration mode. In some embodiments, user actuation of the registration mode input device 136 (e.g., pressing a button) causes provisioning logic/data 142 to identify the current status of Registrar Device 106, and enable the Registrar AP Mode if Registrar Device 106 is pre-provisioned with network security credentials 146. As discussed above, in the Registrar AP Mode, Registrar Device 106 acts as an access point to which an Enrollee Device 108 can connect (as a Wi-Fi station) in order to obtain the network security credentials from Registrar Device 106.

In embodiments in which Registrar Device 106 is an Enrollee/Registrar Device, registration mode input device 136 (or multiple registration mode input devices 136) may be configured for both (a) placing the device 106 into a registration mode for provisioning another Enrollee Device 108 and (b) placing the device 106 into an enrollment mode for provisioning itself via another pre-provisioned Registrar Device 106. In such embodiment, user actuation of the registration mode input device 136 may cause provisioning logic/data 142 to identify whether the Enrollee/Registrar Device 106 is pre-provisioned with network security credentials 146. If the Enrollee/Registrar Device 106 is pre-provisioned with network security credentials 146, provisioning logic/data 142 may enable a registration mode (Registrar AP Mode) to facilitate a provisioning of another Enrollee Device; if the Enrollee/Registrar Device 106 is not pre-provisioned with network security credentials 146, provisioning logic/data 142 may enable an enrollee mode to provision itself, by locating and connecting to a pre-provisioned Registrar Device 106 to obtain the network security credentials. In other embodiments, an Enrollee/Registrar Device 106 may automatically enter into the enrollee mode upon being powered on (e.g., plugged in or switched on).

Each Enrollee Device 108, such as Enrollee Device 108A shown in FIG. 1, may include a processor 160, memory 162, transmitter/receiver unit 164, wired connection interface(s) 174, an enrollment mode input device 176, and other various other electronic components. Processor 160 may include one or more general purpose microprocessor, microcontroller, Application Specific System Processor (ASSP), Application Specific Integrated Circuit (ASIC), Digital Signal Processor (DSP), or any other devices for executing computer instructions.

Memory 162 may include one or more data storage devices, for example, any one or combination of hard drives, RAM, ROM, EEPROM, Flash memory, removable memory device (e.g., USB drives or MSD). Memory 162 may store executable instructions and other data relevant to provide the various functionality of Enrollee Device 108. For example, memory 162 may store one or more device applications 180, provisioning logic/data 182, a digital certificate 184, and network security credentials 146 (e.g., if received from Registrar Device 106 or Provisioning Device 110). Device applications 180 may include executable code (e.g., software, logic instructions, or computer readable instruction which may enable processor 160 to perform functions described herein) and data for operating the Enrollee Device 108, including managing wireless interface 170A and/or 170B, discussed below.

Provisioning logic/data 182 may include executable code (e.g., software, logic instructions, or computer readable instruction which may enable processor 160 to perform functions described herein) and data (a) to facilitate provisioning of the Registrar Device 106 by a conventional/manual technique via a manual provisioning device 110 (e.g., when no pre-provisioned Registrar Device 106 is present in the network), and (b) to provide Wi-Fi enrollee functionality for automated provisioning of the Enrollee Device 108 to the Wi-Fi network, e.g., by obtaining network security credentials from a pre-provisioned Registrar Device (e.g., Registrar Device 106 in the example scenario of FIG. 1) and using the obtained network security credentials to connect the Enrollee Device 108 to the Wi-Fi access point 102.

Where the Enrollee Device 108 is a Registrar/Enrollee Device, provisioning logic/data 182 may also include executable code (e.g., software, logic instructions, or computer readable instruction which may enable processor 1620 to perform functions described herein) and data to provide Wi-Fi registrar functionality to facilitate automated provisioning of other Enrollee Devices 108 (by sharing network security credentials 146 with such other Enrollee Devices 108), for example in a situation in which the Registrar/Enrollee Device 108 is connected to the network (e.g., by a conventional provisioning technique) when no other pre-provisioned Registrar Device is present in the network, such that the Registrar/Enrollee Device 108 acts as a Registrar Device to a subsequently added Enrollee Devices 108.

Provisioning logic/data 182 may include one or more software libraries, APIs, and/or other types of computer-readable code and/or data.

Digital certificate 184 may comprise a signed digital certificate, e.g., a digital file signed by a manufacturer or vendor of Device 2, which may be used by other Wi-Fi devices (e.g., Device 1) to authenticate Device 2 before sharing sensitive information, e.g., during a TLS mutual authentication process such as discussed below with reference to FIG. 2 (step 232) and FIG. 3B (“TLS MUTUAL AUTHENTICATION”). Digital certificate 184 may comprise the same certificate (e.g., file) as the digital certificate 144 stored in memory 142 of Device 1.

Transmitter/receiver unit 164 may include any hardware, circuitry, software, and/or firmware for transmitting and receiving wireless communications.

As with Registrar Device 106 discussed above, each Enrollee Device 108 may be (a) a single-interface device including a single wireless interface 170A allowing a single wireless connection at any given time via transmitter/receiver unit 164, or (b) a dual-interface device including two wireless interfaces 170A and 170B allowing two concurrent wireless connections via transmitter/receiver unit 164. Each wireless interfaces 170A, 170B may include any suitable hardware, circuitry, software, and/or firmware for providing a discrete wireless interface via transmitter/receiver unit 164.

A single-interface Enrollee Device 108 may use the single wireless interface 170A to connect with and obtain network security credentials 146 from Registrar Device 106 (or alternatively, from a manual provisioning device 110), save the network security credentials 146 in memory 162, and use the obtained network security credentials 146 to connect with the Wi-Fi access point 102. A dual-interface Enrollee Device 108 may use one wireless interface 170A to connect with and obtain network security credentials 146 from Registrar Device 106 (or manual provisioning device 110), and then use either the same wireless interface 170A or the other wireless interface 170B to connect with the Wi-Fi access point 102.

Wired connection interface(s) 174 may include one or more physical interface (e.g., port, slot, cable, etc.), for example a USB port or USB cable, for physically connecting Enrollee Device 108 to corresponding wired connection interface(s) 194 of manual provisioning device 110 for wired provisioning of Enrollee Device 108.

Enrollment mode input device 176 may include any physically actuatable device or element, for example a button, switch, slider, or touch screen arranged to detect a predetermined gesture, for placing Enrollee Device 108 into an enrollment mode. In some embodiments, user actuation of the enrollment mode input device 176 (e.g., pressing a button) causes provisioning logic/data 182 to identify the current status of Enrollee Device 108, and enable the enrollment mode if Enrollee Device 108 is not yet provisioned. Upon enabling the enrollment mode, Enrollee Device 108 may initiate a scan for a pre-provisioned Registrar Device 106. In other embodiments, Enrollee Device 108 may automatically enter into the enrollee mode upon being powered on (e.g., plugged in or switched on), and thus the enrollment mode input device 176 may be omitted.

Manual provisioning device 110 may be configured to provision Wi-Fi Devices 104 (including Registrar Devices 106 and/or Enrollee Device 108) by any conventional or known provisioning process, typically requiring manual participation, e.g., inputting the network security credentials using a keyboard, keypad, or other user interface. Manual provisioning device 110 may comprise a personal computer, laptop, smartphone, tablet, or any other type of computer device including a provisioning application 190 for managing manual provisioning of a Wi-Fi Device 104, and may include at least one wired connection interface 194 (e.g., USB port or cable) and/or wireless connection interface 196 (e.g., antenna) for establishing a wired or wireless connection with the Wi-Fi Device 104 being provisioned.

In one embodiment, provisioning application 190 may comprise a terminal program for provisioning a Wi-Fi Device 104 by terminal commands, wherein a user inputs network security credentials into the terminal program, which are thereby stored on the Wi-Fi Device 104 and then used by the Wi-Fi Device 104 to connect to the Wi-Fi access point 102.

In another embodiment, provisioning application 190 may comprise a mobile provisioning application downloaded by a user for provisioning a particular Wi-Fi Device 104. The downloaded mobile provisioning application 190 may be preconfigured with an access point name for Wi-Fi access point 102. The user may input the access point name and a network password into the mobile provisioning application, which then attempts to connect to Wi-Fi access point 102 using these credentials. If the mobile provisioning application 190 successfully connects to Wi-Fi access point 102 using the user-input network security credentials, the provisioning application 190 then sends the network security credentials to the Wi-Fi device 104, which may then use such credentials to connect to Wi-Fi device 104.

In another embodiment, manual provisioning device 110 may be configured to provision a Wi-Fi device 104 using an MSD. A user may physically connect the Wi-Fi device 104 to the manual provisioning device 110 via USB, generate a text file including the network security credentials using a predefined format (typically defined by the manufacturer/vendor of the Wi-Fi device 104 being provisioned), and drag-and-drop the file from the manual provisioning device 110 to the MSD. The Wi-Fi device 104 may then read the text file from the MSD to obtain the network security credentials, and then use such credentials to connect to Wi-Fi access point 102.

FIG. 1 also illustrates an example process for provisioning the illustrated Registrar Device 106 and a first Enrollee Device 108A, with reference to the encircled numbers that indicate the sequential order of events in the example process. First, as indicated by encircled number 1, a user may utilize a provisioning device 110 to manually provision the Registrar Device 106 using a conventional or known provisioning technique, e.g., as discussed above. For example, the user may interact with a provisioning application 190 displayed at the provisioning device 110 to input the network security credentials 146 for Wi-Fi access point 102, which are then stored on the Registrar Device 106 in the memory 122.

As indicated by encircled number 2, the Registrar Device 106 may then use the network security credentials 146 to connect to the Wi-Fi access point 102 to join the relevant network.

Later, an Enrollee Device 108A may be introduced to be added to the network. If the provisioned Registrar Device 106 is still present in the network, a user may attempt to initiate an automated provisioning of Enrollee Device 108A, as indicated by encircled number 3A. In one embodiment, to attempt an automated provisioning, the user may (a) enable the Registrar AP Mode of the Registrar Device 106 by actuating a registration mode input device 136 on Registrar Device 106 (e.g., pressing a designated button), which may start a registration timer of a defined time-out duration (e.g., 2 minutes); and then (b) prior to expiration of the registration timer, enable the enrollment mode of the Enrollee Device 108A by powering-up the Enrollee Device 108A or by actuating an enrollment mode input device 176 on Enrollee Device 108A (e.g., pressing a designated button), depending on the particular configuration of Enrollee Device 108A.

Upon enabling the enrollment mode of the Enrollee Device 108A, Enrollee Device 108A may initiate a wireless connection with Registrar Device 106, as indicated encircled number 3A, the two devices may authenticate each other, and Registrar Device 106 may then share the network security credentials with Enrollee Device 108A. This process is discussed in greater detail below. After obtaining the network security credentials, Enrollee Device 108A may then connect to the Wi-Fi access point 102, as indicated by the encircled number 4.

Alternatively, if the user is unable to initiate the automated provisioning of Enrollee Device 108A, or if the automated provisioning fails for another reason, the user may use the provisioning device 110 (or another suitable provisioning device) to manually provision the Enrollee Device 108A using a conventional or known provisioning technique, as indicated by the encircled number 3B.

Additional Enrollee Devices 108 may be added to the network by automated provisioning via Registrar Device 106 (if present), as indicated by encircled number N.

FIG. 2 shows a flowchart of an example method 200 for provisioning Wi-Fi devices to a network, according to one example embodiment. In this example method, it is assumed that each Wi-Fi device introduced to the network is a Registrar/Enrollee Device. At 202, a first Wi-Fi device (Device 1) is introduced to be provisioned. The method then proceeds based on whether there is currently a pre-provisioned Wi-Fi device (PPD) present in the network when Device 1 is introduced, and based on selected actions of the user. As indicated at 204, if a PPD is currently present in the network, the user may chose to initiate an automated provisioning of Device 1 using the existing PPD as disclosed herein, which involves two actions by the user, at steps 220 and 222, which are discussed in detail below. Alternatively, as indicated at 205, if (a) there is no PPD currently present in the network when Device 1 is introduced, or (b) a PPD is present but the user does not chose to initiate an automated provisioning of Device 1 using the PPD, the method may proceed to 206.

For the sake of illustration, the following discussion assumes a situation in which there is no PPD currently present in the network when Device 1 is introduced, such that the method proceeds to 206. At 206 the user may power on Device 1, which automatically enables an enrollment mode of Device 1 (or in alternative embodiments, the user may engage a defined user interface, e.g., a designated button or switch to enable the enrollment mode of Device 1). In response to the enrollment mode being enabled, Device 1 scans for a PPD's access point at 208, which is not located (as not PPD is present). Thus, at 210, Device 1 awaits manual provisioning.

At 212, a user may manually provision Device 1 using a provisioning device 110, to provide Device 1 with network security credentials, e.g., a Wi-Fi access point name and a network password, which are then stored in Device 1. At 214, Device 1 may then automatically connect with the Wi-Fi access point (“Network AP”) using the network security credentials obtained and stored at 212. As shown in more detail in FIG. 3A discussed below, the process of Device 1 connecting to Network AP may include known steps of a Wi-Fi scan process, a Wi-Fi connect process, and a 4-way handshake.

After Device 1 connects to the Network AP to join the network, Device 1 may act as a Registrar Device for subsequently introduced Wi-Fi devices, and the method awaits the introduction of a next Wi-Fi device as indicated at 216. When another Wi-Fi device (Device 2) is subsequently introduced at 202, the method again proceeds based on whether there is currently a PPD present in the network, and based on selected actions of the user, i.e., as defined at 204 and 205 discussed above. In this instance, a PPD (namely, Device 1) is now present, so at 204 the user may choose to initiate an automated provisioning of Device 2, thus proceeding to steps 220 and 222; or alternately may not choose to initiate an automated provisioning of Device 2 (as indicated at 205), thus proceeding to step 206 for manual provisioning of Device 2.

If the user elects at 204 to initiate an automated provisioning of Device 2, the user may perform two actions to initiate such automated provisioning, at steps 220 and 222. First, at 220 the user may enable the Registrar AP Mode of Device 1 by actuating a registration mode input device on Device 1, e.g., by pressing a button designated for enabling the Registrar AP Mode. If Device 1 includes two (or more) wireless interfaces (e.g., wireless interfaces 130A and 130B shown in FIG. 1), Device 1 may maintain its network connection via the Network AP via a first wireless interface, and concurrently enable a second wireless interface as a Wi-Fi access point to which Device 2 (acting as a Wi-Fi station) may connect.

Alternatively, as indicated at 220A, if Device 1 includes only one wireless interface, Device 1 may temporarily disconnect the wireless interface from the Network AP and enable the one wireless interface to act as a Wi-Fi access point to which Device 2 may connect. In other words, Device 1 may transition from acting as a Wi-Fi station (Registrar STA Mode) to acting as a Wi-Fi access point (Registrar AP Mode). As discussed below, after facilitating the automated provisioning of Device 2, Device 1 may switch its single wireless interface back to station mode and reconnect with the Network AP.

In some embodiments, the Registrar AP Mode is only temporarily enabled, for a defined time period, for example 1 minute. Thus, Device 1 may start a provisioning timer when the user actuates the registration mode input device (e.g., button press) to enable the Registrar AP Mode. If another Wi-Fi device (e.g., Device 2 or other device) has not connected to Device 1 before the expiration of the provisioning timer, or in another embodiment, if another Wi-Fi device (e.g., Device 2 or other device) has not completed the automated provisioning process steps 226-236 before the expiration of the provisioning timer, Device 1 may automatically disable the Registrar AP Mode.

At 222, the user may enable an enrollment mode of Device 2 before the provisioning timer expires, e.g., by powering on the device or by actuating an enrollment mode input device on Device 2 (pressing a button on Device 2 designated for enabling the enrollment mode), depending on the particular configuration of Device 2. If the enrollment mode of Device 2 is enabled at 222, the method may then proceed to 224. Alternatively, if the user does not enable the enrollment mode of Device 2 before the provisioning timer expires, the method may return to step 204, where the user may again attempt the two-step initiation (at 220 and 222) of the automated provisioning process, or may elect to proceed to 205-206 for manual provisioning of Device 2.

At 224, in response to enabling the enrollment mode of Device 2, Device 2 automatically initiates a Wi-Fi scan by transmitting a probe request to search for an access point provided by a PPD (corresponding to the “Wi-Fi scan” step shown in FIG. 3A). In one embodiment, Device 2 may be programmed to scan for a registrar access point (AP) having a predefined SSID format used by the manufacturer, vendor or other entity associated with the PPD (e.g., XYZCompanySmartDevice_<MAC_ADDR>), for example to locate an access point having the following SSID: XYZCompany_112233445566.

At 226, the method proceeds based on whether a PPD access point is located. In this instance, Device 2 may locate the Wi-Fi access point provided by Device 1 (while the Registrar AP Mode of Device 1 remains enabled) and thus proceed to 228. Alternatively, if Device 2 does not locate Device 1's access point, the method may return to step 204, where the user may again attempt the two-step initiation (at 220 and 222) of the automated provisioning process, or may elect to proceed to 205-206 for manual provisioning of Device 2.

At 228, Device 2 may connect to the Wi-Fi access point of Device 1, e.g., by sending device authentication information to Device 1 for authenticating Device 2 (corresponding to the “Wi-Fi connect” step shown in FIG. 3A). In one embodiment, first, the PPD AP of Device 1 may be WPA2/WPA3 secured with a passphrase that consists of a proprietary hash of Device 1's MAC address, so that Device 2 may be pre-programmed with knowledge of Device 1's passphrase (e.g., if Device 1 and Device 2 are manufactured or programmed by the same manufacturer/vendor/etc.). For example, continuing with the example MAC address discussed above at step 224, Device 1's access point may have a passphrase of “hash_fn(112233445566).” Thus, at 228 Device 2 may send Device 1 this pre-programmed passphrase allowing Device 1 to authenticate Device 2.

Next, at 230, Device 2 and Device 1 may perform a handshaking, e.g., a 4-way handshaking according to known protocols (corresponding to the “4-way handshake” step shown in FIG. 3A). After this handshaking, at 232 Device 2 and Device 1 may perform a TLS (transport layer security) mutual authentication, in which each device authenticates the other device based on information received from the other device. For example, Device 2 may authenticate Device 1 based on a first digital certificate stored in Device 1 and transmitted to Device 2, and Device 1 may authenticate Device 2 based on a second digital certificate (same as or different from the first digital certificate) stored in Device 2 and transmitted to Device 1.

After the TLS mutual authentication, at 234 Device 1 may send Device 2 an encrypted message including Network Security Credentials, and Device 2 may store the received Network Security Credentials in memory. At 236, Device 2 may then use the Network Security Credentials obtained from Device 1 to connect to the Network AP.

At 238, which may be performed before, after, or simultaneous with step 236, Device 1 may automatically disable the Registrar AP Mode upon sending the Network Security Credentials, or may wait until expiration of the provisioning timer. If Device 1 includes only one wireless interface, which was disconnected from the Network AP at 220A in order to provide an access point to facilitate the provisioning of Device 2, the wireless interface may automatically reconnect to the Network AP at 238A, to restore Device 1 to the station mode, i.e., Registrar STA Mode, with respect to the Network AP.

After connecting Device 2 to the Network AP as discussed above, the method may proceed to 216 to provision another Wi-Fi device.

In the example method 200 shown in FIG. 2, to initiate the automated provisioning of Device 2, the user must enable the enrollment mode of Device 2 (e.g., by powering on Device 2 or by pressing a designated button on Device 2) after enabling the Registrar AP Mode of Device 1 (e.g., by pressing a designated button on Device 1), and before expiration of the provisioning timer.

In other embodiments, the user must enable the enrollment mode of Device 2 prior to enabling the Registrar AP Mode of Device 1. For example, Device 2 may be configured such that upon enablement of the enrollment mode, Device 2 may periodically scan for a PPD access point (i.e., step 224) for a predefined scanning period. If the Registrar AP Mode of Device 1 is enabled during the predefined scanning period, Device 2 may locate and connect to the access point provided by Device 1.

In other embodiments, the user may enable the enrollment mode of Device 2 and the Registrar AP Mode of Device 1 in either order, but both within a specified time period defined by a timer initiated by Device 1, by a timer initiated by Device 2, or by the first-expiring or last-expiring of respective timers initiated by Device 1 and Device 2, for example. As discussed above, Device 2 may be configured to periodically scan for a PPD access point (i.e., step 224) for a predefined scanning period after entering the enrollment mode (e.g., after being powered on or after a defined user button press on Device 2).

In alternative embodiments, Device 1 may keep the Registrar AP Mode enabled continuously, or may automatically enable the Registrar AP Mode periodically (e.g., every 20 seconds), such that a user may initiate the automatic provisioning of Device 2 without any manual interaction with Registrar AP Mode (e.g., pressing a button on Device 1). In such embodiment, step 220 may be omitted, and step 222 may be modified such that Device 2 may be powered on at any time, thus omitting the timing requirement of step 222 (i.e., to power on Device 2 before a provisioning timer expires). For example, in an implementation in which Device 1 includes two (or more) wireless interfaces (e.g., wireless interfaces 130A and 130B shown in FIG. 1), Device 1 may (a) maintain its network connection via the Network AP via a first wireless interface, and (b) continuously maintain a second wireless interface as a Wi-Fi access point to which Device 2 may connect, or periodically (e.g., every 20 seconds) enable the second wireless interface as a Wi-Fi access point for a brief duration (e.g., 1 second) to allow Device 2 to locate Device 1's Wi-Fi access point during the access point scan performed by Device 2 at step 224.

FIGS. 3A and 3B shows an example process 300 for (a) connecting a first Wi-Fi device, Device 1, to a Wi-Fi access point (“network AP”) using a conventional provisioning process (FIG. 3A), and (b) subsequently provisioning a second Wi-Fi device, Device 2, by obtaining network security credentials from Device 1 and using such credentials to connect to the network AP (FIG. 3B), according to one example embodiment. The devices shown in FIGS. 3A and 3B correspond with devices shown in FIG. 1, namely a Network AP 102, a provisioning device 110 (“PC terminal”), a Registrar Device 106 (Device 1), and an Enrollee Device 108 (Device 2).

First, FIG. 3A shows the provisioning of a first Wi-Fi device, Device 1, using an example conventional provisioning process. In this example, Device 1 is provisioned by a user with “terminal commands” via a PC Terminal, i.e., provisioning device 110. First, the user may physically connect Device 1 to the PC terminal via USB connection. The, in the “custom device commands” step, the user may open a terminal program on the PC Terminal, and type a series of custom commands to program Device 1 with the network security credentials of the network. For example, the user may enter the SSID of the Network AP 102 (WLAN SET SSID <ssid>), an authentication setting of the Network AP 102 (WLAN SET AUTHENTICATION <auth>, and a network password (WLAN SET PASSPHRASE <password>, and instruct Device 1 to apply the WLAN configuration (WLAN APPLY CONFIG). Device 1 then uses the network security credentials to connect to the Network AP 102 by a processing including a “Wi-Fi scan” set, including sending a PROBE REQUEST and receiving a PROBE RESPONSE, a “Wi-Fi connect” step, including sending an AUTHENTICATION REQUEST and receiving an AUTHENTICATION REPONSE, sending an ASSOCIATION REQUEST and receiving an ASSOCIATION RESPONSE and a “4-way handshake” step including receiving KEY 1/4, sending KEY 2/4, receiving KEY 3/4 and transmitting KEY 4/4, as shown in FIG. 3A.

Moving now to FIG. 3B, after Device 1 is provisioned, a second Wi-Fi device, Device 2, may be introduced for provisioning. Device 2 may be provisioned using the automated provisioning process discussed herein, wherein Device 1 and Device 2 act as a Registrar Device 106 and an Enrollee Device 108, respectively. To initiate the automated provisioning process, the user may (a) press a designated button on Device 1 to enable the Registrar AP Mode, thereby configuring a wireless interface of Device 1 as an access point (indicated in FIG. 3B at “AP interface enabled”) and (b) powering up Device 2, which enables the enrollment mode of Device 2. As discussed above, Device 1 and Device 2 may or may not require a particular order and timing of user actions (a) and (b), depending on the particular embodiment.

Upon initiating the automated provisioning process, the remainder of the provisioning process for Device 2 may be completed fully automatically, i.e., without human participation. First, Device 2 may cooperate with Device 1 to perform (a) a Wi-Fi scan process, (b) a Wi-Fi connect process, and (c) a 4-way handshaking process, which may include the same steps in the corresponding processes shown in FIG. 3A during the connection and authentication of Device 1 with the Network AP.

After the connection and handshaking, Device 2 may initiate a TCP socket open process, according to known protocols, including sending a SYN, receipt of a SYN ACK and sending an ACK. After the TCP socket open process, Device 2 and Device 1 may perform a TLS (transport layer security) mutual authentication process, in which Devices 1 and 2 exchange messages (e.g., including signed digital certificates) and agree on a shared key for a further layer of data encryption (transport layer level encryption). In the illustrated example, the TLS mutual authentication may begin with a ClientHello message from Device 2, advertising that Device 1 is a TCP client and wants to establish a keyless connection with Device 1, followed by a ServerHello response from Device 1 including data regarding Device 1, e.g., a TLS version used by Device 1.

Device 1 may then send a ServerCertificate message to Device 2 including a signed certificate stored in Device 1, e.g., stored by a manufacturer or vendor of Device 1, followed by a ClientCertificateRequest message requesting Device 2 to send over its signed certificate, so that both devices can authenticate each other, and followed by a ServerHelloDone message indicating that Device 1 is finished with the current set of requests.

In response, Device 2 may verify the Device 1 digital certificate, and in response to the ClientCertificateRequest message, send a ClientCertificate message to Device 1 including a signed certificate stored in Device 2, e.g., stored by a manufacturer or vendor of Device 2, followed by a ClientKeyExchange message including a encrypted shared key used for a further level of data encryption later in the process. Device 2 may further send a ClientCertificateVerify message indicating that Device 2 has verified the Device 1 digital certificate received from Device 1.

Device 2 may then send a ChangeCipherSpec message including a request to change the messaging protocol to encrypted communications using the shared key (for transfer of the network security credentials, discussed below), and ending with a FINISHED message. The shared key may be generated by each device (Device 1 and Device 2) based on a public key, which is included in the signed certificates sent by each device, and a private key stored in each device (and not included in the signed certificates sent by each device).

In response to the messaging from Device 2, Device 1 may verify the Device 2 digital certificate received from Device 2, and continue the process by sending Device 2 a ChangeCipherSpec message indicating that Device 1 agrees to change the messaging protocol to encrypted communications using the shared key, followed by a FINISH message.

After the devices have agreed to the encrypted communications protocol using the shared key (via the ChangeCipherSpec messages), Device 2 may initiate an exchange of network credentials process by sending an encrypted message requesting network security credentials for the Network AP, and Device 1 may respond with an encrypted message including the requested network security credentials.

In this manner, Device 2 may be automatically provisioned and connected to the network, after minimum actions by a user to trigger such automatically provisioning, e.g., by pressing a button on Device 1 and powering-on or pressing a button on Device 2. In this way, Wi-Fi devices may be added to the network in a seamless automated manner, without the need for a user to manually enter the network security credentials or download and operate a mobile provisioning application.

Although the disclosed embodiments are described in detail in the present disclosure, it should be understood that various changes, substitutions and alterations can be made to the embodiments without departing from their spirit and scope.

1. A method for provisioning Wi-Fi devices to a Wi-Fi network, the method comprising:
connecting a first Wi-Fi device to a Wi-Fi access point using a first provisioning process;
after connecting the first Wi-Fi device to the Wi-Fi access point, connecting a second Wi-Fi device to the Wi-Fi access point by a second provisioning process, wherein the second provisioning process for the second Wi-Fi device to the Wi-Fi access point includes:
establishing a wireless communication connection between the first Wi-Fi device and the second Wi-Fi device;
the second Wi-Fi device obtaining access point authentication information from the first Wi-Fi device via the established wireless communication connection, the access point authentication information allowing authenticated connection to the Wi-Fi access point; and
the respective second Wi-Fi device using the access point authentication information received from the first Wi-Fi device to connect to the Wi-Fi access point.

2. The method of claim 1, wherein the second provisioning process for the second Wi-Fi device to the Wi-Fi access point further includes, prior to the second Wi-Fi device obtaining the access point authentication information from the first Wi-Fi device:
the second Wi-Fi device authenticating the first Wi-Fi device based on first device authentication information received from the first Wi-Fi device; and
the first Wi-Fi device authenticating the respective second Wi-Fi device based on second device authentication information received from the respective second Wi-Fi device.

3. The method of claim 2, wherein the second device authentication information comprises a digital certificate stored in the second Wi-Fi device.

4. The method of claim 1, wherein the first Wi-Fi device is configured to operate in both (a) a station mode in which the first Wi-Fi device acts as a slave to the Wi-Fi access point and (b) an access point mode in which the first Wi-Fi device acts as a Wi-Fi access point to the respective second Wi-Fi device to enable the transfer of the access point authentication information to the respective second Wi-Fi device for provisioning the second Wi-Fi device.

5. The method of claim 4, wherein the first Wi-Fi device is configured to concurrently operate in both the station mode and the access point mode.

6. The method of claim 4, wherein the first Wi-Fi device is configured to operate alternatively in the station mode and the access point mode.

7. The method of claim 4, wherein the second provisioning process for the second Wi-Fi device further includes, prior to the second Wi-Fi device obtaining the access point authentication information from the first Wi-Fi device:
the first Wi-Fi device activating the access point mode; and
the second Wi-Fi device activating an enrollment mode.

8. The method of claim 7, wherein activating the access point mode for the first Wi-Fi device comprises a user pressing a physical interface provided on the first Wi-Fi device.

9. The method of claim 7, wherein the activating of the enrollment mode of the second Wi-Fi device is performed after the activating of the access point mode of the first Wi-Fi device, and automatically triggers the second Wi-Fi device to transmits an access point probe,
wherein the access point probe transmitted by the second Wi-Fi device is received by the first Wi-Fi device in the access point mode, and
wherein the first Wi-Fi device transmits to the second Wi-Fi device a response to the access point probe.

10. The method of claim 7, wherein activating the enrollment mode of the second Wi-Fi device comprises powering on the second Wi-Fi device.

11. The method of claim 7, wherein after the activating the access point mode of the first Wi-Fi device and the activating the enrollment mode of the second Wi-Fi device, the second Wi-Fi device obtaining the access point authentication information from the first Wi-Fi device and the second Wi-Fi device using the access point authentication information to connect to the Wi-Fi access point are performed automatically without human participation.

12. The method of claim 1, wherein the access point authentication information is stored in the first Wi-Fi device during the first provisioning process.

13. The method of claim 1, wherein connecting the first Wi-Fi device to the Wi-Fi access point using the first provisioning process comprises one of:
manual entry of terminal commands;
using a mobile provisioning application to communicate access point authentication information to the first Wi-Fi device; or
using a mass storage device.

14. A method for provisioning a second Wi-Fi device to a Wi-Fi access point of a Wi-Fi network having a first Wi-Fi device previously provisioned to the Wi-Fi access point, the method comprising:
entering the first Wi-Fi device into an access point mode allowing wireless communications with the second Wi-Fi device;
entering the second Wi-Fi device into an enrollment mode;
while the first Wi-Fi device is in the access point mode and the second Wi-Fi device is in the enrollment mode, the first and second Wi-Fi devices automatically performing a provisioning information exchange including:
establishing a wireless communication connection between the first and second Wi-Fi devices;
using the established wireless communication connection, performing a device authentication process including:
the second Wi-Fi device communicating second Wi-Fi device authentication information stored in the second Wi-Fi device to the first Wi-Fi device; and
the first Wi-Fi device authenticating the second Wi-Fi device based on the second Wi-Fi device authentication information received from the second Wi-Fi device;
after the device authentication process, the first Wi-Fi device communicating access point authentication information to the second Wi-Fi device, the access point authentication information allowing authenticated connection to the Wi-Fi access point; and
the second Wi-Fi device using the access point authentication information received from the first Wi-Fi device to connect the second Wi-Fi device to the Wi-Fi access point.

15. The method of claim 14, wherein the device authentication process further includes:
the first Wi-Fi device communicating first Wi-Fi device authentication information stored in the first Wi-Fi device to the second Wi-Fi device;
the second Wi-Fi device authenticating the first Wi-Fi device based on the first Wi-Fi device authentication information received from the first Wi-Fi device.

16. The method of claim 14, wherein the second Wi-Fi device authentication information used by the first Wi-Fi device for authenticating the second Wi-Fi device comprises a digital certificate stored in the second Wi-Fi device.

17. The method of claim 14, wherein entering the first Wi-Fi device into the access point mode comprises a user pressing a physical interface provided on the first Wi-Fi device.

18. The method of claim 14, wherein the step of entering the second Wi-Fi device into the enrollment mode is performed after the step of entering the first Wi-Fi device in the access point mode, and automatically triggers the provisioning information exchange.

19. The method of claim 14, wherein the step of entering the second Wi-Fi device into the enrollment mode is performed after the step of entering the first Wi-Fi device in the access point mode, and automatically triggers the second Wi-Fi device to initiate the provisioning information exchange by transmitting an access point probe,
wherein the access point probe transmitted by the second Wi-Fi device is received by the first Wi-Fi device in the access point mode, and
wherein the first Wi-Fi device transmits to the second Wi-Fi device a response to the access point probe.

20. The method of claim 14, wherein entering the second Wi-Fi device into an enrollment mode comprises powering on the second Wi-Fi device.

21. The method of claim 14, wherein after the first Wi-Fi device enters into the access point mode and the second Wi-Fi device enters into the enrollment mode, the provisioning information exchange and the connection of the second Wi-Fi device to the Wi-Fi access point are performed automatically without human participation.

22. The method of claim 14, wherein the access point authentication information is stored in the first Wi-Fi device during the previous provisioning of the first Wi-Fi device.

23. A system comprising:
a Wi-Fi access point;
a first Wi-Fi device configured to be connected to the Wi-Fi access point by a first provisioning process; and
at least one second Wi-Fi device;
wherein each respective second Wi-Fi device is configured to interact with the first Wi-Fi device to connect the respective second Wi-Fi device to the Wi-Fi access point by a second provisioning process including:
the first Wi-Fi device activating an access point mode allowing wireless communications with the respective second Wi-Fi device;
the respective second Wi-Fi device activating an enrollment mode;
establishing a wireless communication connection between the first Wi-Fi device in the access point mode and the respective second Wi-Fi device in the enrollment mode;
the respective second Wi-Fi device obtaining access point authentication information from the first Wi-Fi device via the establishing wireless communication connection, the access point authentication information allowing authenticated connection to the Wi-Fi access point; and
the respective second Wi-Fi device using the access point authentication information received from the first Wi-Fi device to connect to the Wi-Fi access point.

24. A method for provisioning Wi-Fi devices to a Wi-Fi network, comprising:
connecting a first Wi-Fi device to a Wi-Fi access point using a first provisioning process;
after connecting the first Wi-Fi device to the Wi-Fi access point, connecting at least one second Wi-Fi device to the Wi-Fi access point by a second provisioning process, wherein the second provisioning process for connecting each respective second Wi-Fi device to the Wi-Fi access point includes:
entering the first Wi-Fi device into an access point mode allowing wireless communications with other non-provisioned Wi-Fi device;
entering the respective second Wi-Fi device into an enrollment mode;
the first Wi-Fi device and the respective second Wi-Fi device automatically performing a provisioning information exchange including:
establishing a wireless communication connection between the first Wi-Fi device in the an access point mode and the respective second Wi-Fi device in the enrollment mode
using the established wireless communication connection, performing a device authentication process including:
the respective second Wi-Fi device communicating Wi-Fi device authentication information stored in the respective second Wi-Fi device to the first Wi-Fi device; and
the first Wi-Fi device authenticating the respective second Wi-Fi device based on the Wi-Fi device authentication information received from the respective second Wi-Fi device;
after the device authentication process, the first Wi-Fi device communicating access point authentication information to the respective second Wi-Fi device, the access point authentication information allowing authenticated connection to the Wi-Fi access point; and
the respective second Wi-Fi device using the access point authentication information received from the first Wi-Fi device to connect to the Wi-Fi access point.

25. A method, comprising:
a first Wi-Fi device connecting to a Wi-Fi access point;
entering the first Wi-Fi device into an access point mode allowing wireless communications with other Wi-Fi devices; and
while the first Wi-Fi device is in the access point mode:
the first Wi-Fi device establishing a wireless communication connection with a second Wi-Fi device;
the first Wi-Fi device performing a device authentication process with the second Wi-Fi device, including:
the first Wi-Fi device receiving Wi-Fi device authentication information from the second Wi-Fi device; and
the first Wi-Fi device authenticating the second Wi-Fi device based on the Wi-Fi device authentication information received from the second Wi-Fi device;
after the device authentication process, the first Wi-Fi device communicating access point authentication information to the second Wi-Fi device, the access point authentication information allowing the second Wi-Fi device to connect to the Wi-Fi access point.

26. A method for provisioning a second Wi-Fi device to a Wi-Fi access point of a Wi-Fi network having a first Wi-Fi device previously provisioned to the Wi-Fi access point, the method comprising:
entering the second Wi-Fi device into an enrollment mode; and
while the second Wi-Fi device is in the enrollment mode:
the second Wi-Fi device establishing a wireless communication connection with the first Wi-Fi device;
the second Wi-Fi device performing a device authentication process to authenticate itself with the first Wi-Fi device, including communicating Wi-Fi device authentication information stored in the second Wi-Fi device to the first Wi-Fi device;
in response to a successful completion of the device authentication process, the second Wi-Fi device receiving access point authentication information from the first Wi-Fi device; and
the second Wi-Fi device using the access point authentication information received from the first Wi-Fi device to connect the second Wi-Fi device to the Wi-Fi access point.
